(19) United States
(12) Patent Application Publication
(10) Pub. No.: US 2018/0339764 A1
(43) Pub. Date: Nov. 29, 2018

(54) FLY-BY-WIRE MECHANICAL CONTROL SYSTEM

(71) Applicant: Sikorsky Aircraft Corporation, Stratford, CT (US)

(72) Inventors: Ashley M. Currivan, Milford, CT (US); Paul Shields, New Haven, CT (US)

(21) Appl. No.: 15/905,125

(22) Filed: Feb. 26, 2018

Related U.S. Application Data
(60) Provisional application No. 62/510,324, filed on May 24, 2017.

(51) Int. Cl. B64C 13/50; B64C 27/04

(52) U.S. Cl. CPC B64C 13/503; B64C 27/04

(57) ABSTRACT

A fly-by-wire mechanical control system including at least one engine control spindle mechanically connectable to an aircraft prime mover, at least one engine control cable including a first end connected to the at least one engine control spindle, a second end, and an intermediate portion extending therebetween, and at least one electro-mechanical actuator mechanically connected to the second end of the at least one engine control cable and electrically connected to an aircraft control member.

### CROSS-REFERENCE TO RELATED APPLICATIONS

This application claims the benefit of U.S. Provisional Application Ser. No. 62/510,324, filed May 24, 2017, which is incorporated herein by reference in its entirety.

### STATEMENT OF FEDERAL SUPPORT

This invention was made with Government support under HR0011-15-9-0004 awarded by the Defense Advanced Research Projects Agency (DARPA). The Government has certain rights in the invention.

### BACKGROUND

Exemplary embodiments pertain to the art of vertical take-off and landing (VTOL) aircraft and, more particularly, to a fly-by-wire mechanical control system for a VTOL aircraft.

Conventional VTOL aircraft include control input mechanisms such as a collective, pedals, and a stick. Each of the control input mechanisms are coupled to controllable members, such as a rotor hub, engine control spindles, and the like through corresponding mechanical linkages. That is, there is a direct physical connection between the control input mechanisms and a corresponding controllable members. Overtime, mechanical linkages have been replaced by fly-by-wire systems. More specifically, many newer VTOL aircraft include control input mechanisms that are mechanically isolated from the corresponding controllable members.

In a fly-by-wire system, a control input is converted to an electrical signal. That signal is processed and used to provide the control input to the corresponding controlled member. There is currently an effort underway to retro-fit VTOL aircraft having mechanical systems with newer fly-by wire systems. The effort may include aircraft already in service as well as those currently in production. Removing the mechanical linkages, and re-fitting the VTOL aircraft to accommodate fly-by-wire system is a time consuming and costly process.

### BRIEF DESCRIPTION

Disclosed is a fly-by-wire mechanical control system including at least one engine control spindle mechanically connectable to an aircraft prime mover, at least one engine control cable including a first end connected to the at least one engine control spindle, a second end, and an intermediate portion extending therebetween, and at least one electro-mechanical actuator mechanically connected to the second end of the at least one engine control cable and electrically connected to an aircraft control member.

In addition to one or more of the features described above or below, or as an alternative, further embodiments could include wherein the aircraft control member comprises an aircraft control inceptor.

In addition to one or more of the features described above or below, or as an alternative, further embodiments could include wherein the aircraft control inceptor comprises a collective drive system.

In addition to one or more of the features described above or below, or as an alternative, further embodiments could include wherein the aircraft control member comprises a vehicle management system controller.

In addition to one or more of the features described above or below, or as an alternative, further embodiments could include wherein the at least one electro-mechanical actuator comprises a first electro-mechanical actuator and a second electro-mechanical actuator.

In addition to one or more of the features described above or below, or as an alternative, further embodiments could include wherein the first electro-mechanical actuator comprises at least one power available electro-mechanical actuator and the second electro-mechanical actuator comprises at least one load demand electro-mechanical actuator.

In addition to one or more of the features described above or below, or as an alternative, further embodiments could include a feedback system operatively connected to at least one of the at least one engine control spindle and the at least one electro-mechanical actuator, the feedback control system providing activation state information of the at least one engine control cable.

In addition to one or more of the features described above or below, or as an alternative, further embodiments could include a control inceptor drive system electrically connecting a first control inceptor and a second control inceptor with the at least one electro-mechanical actuator (EMA).

In addition to one or more of the features described above or below, or as an alternative, further embodiments could include wherein the control inceptor drive system includes one or more rotary variable differential transformers (RVDT) operatively connecting the first and second control inceptors with the at least one EMA.

In addition to one or more of the features described above or below, or as an alternative, further embodiments could include wherein the control inceptor drive system includes at least one servo mechanically connected to each of the first and second control inceptors.

Also disclosed is an aircraft including an airframe, a prime mover supported in the airframe, an aircraft control member operatively selectively operable to affect a state of the prime mover, and a fly-by-wire mechanical control system including at least one engine control spindle mechanically connected to the prime mover, at least one engine control cable including a first end connected to the at least one engine control spindle, a second end, and an intermediate portion extending therebetween, and at least one electro-mechanical actuator mechanically connected to the second end of the at least one engine control cable and electrically connected to the aircraft control member.

In addition to one or more of the features described above or below, or as an alternative, further embodiments could include wherein the aircraft control member comprises an aircraft control inceptor.

In addition to one or more of the features described above or below, or as an alternative, further embodiments could include wherein the aircraft control inceptor comprises a collective drive system.

In addition to one or more of the features described above or below, or as an alternative, further embodiments could include wherein the aircraft control member comprises a vehicle management system controller.

In addition to one or more of the features described above or below, or as an alternative, further embodiments could include wherein the at least one electro-mechanical actuator comprises a first electro-mechanical actuator and a second electro-mechanical actuator.

In addition to one or more of the features described above or below, or as an alternative, further embodiments could include wherein the first electro-mechanical actuator comprises at least one power available electro-mechanical actuator and the second engine control spindle comprises at least one load demand electro-mechanical actuator.

In addition to one or more of the features described above or below, or as an alternative, further embodiments could include a feedback system operatively connected to at least one of the at least one engine control spindle and the at least one electro-mechanical actuator, the feedback control system providing activation state information of the at least one engine control cable.

In addition to one or more of the features described above or below, or as an alternative, further embodiments could include a control inceptor drive system electrically connecting a first control inceptor and a second control inceptor with the at least one electro-mechanical actuator (EMA).

In addition to one or more of the features described above or below, or as an alternative, further embodiments could include wherein the control inceptor drive system includes one or more rotary variable differential transformers (RVDT) operatively connecting the first and second control inceptors with the at least one EMA.

In addition to one or more of the features described above or below, or as an alternative, further embodiments could include wherein the control inceptor drive system includes at least one servo mechanically connected to each of the first and second control inceptors.

### BRIEF DESCRIPTION OF THE DRAWINGS

The following descriptions should not be considered limiting in any way. With reference to the accompanying drawings, like elements are numbered alike:

FIG. 1 depicts a rotary wing aircraft including a fly-by-wire mechanical control system, in accordance with an aspect of an exemplary embodiment;

FIG. 2 is a schematic view of the fly-by-wire mechanical control system of FIG. 1, in accordance with an aspect of an exemplary embodiment;

FIG. 3 is a block diagram illustrating a control system for the fly-by-wire mechanical control system, in accordance with an exemplary embodiment;

FIG. 4 depicts a control inceptor drive system for the fly-by-wire mechanical control system, in accordance with an exemplary embodiment;

FIG. 5 depicts a co-pilot portion of the control inceptor drive system, in accordance with an aspect of an exemplary embodiment; and

FIG. 6 depicts a pilot portion of the control inceptor drive system, in accordance with an aspect of an exemplary embodiment.

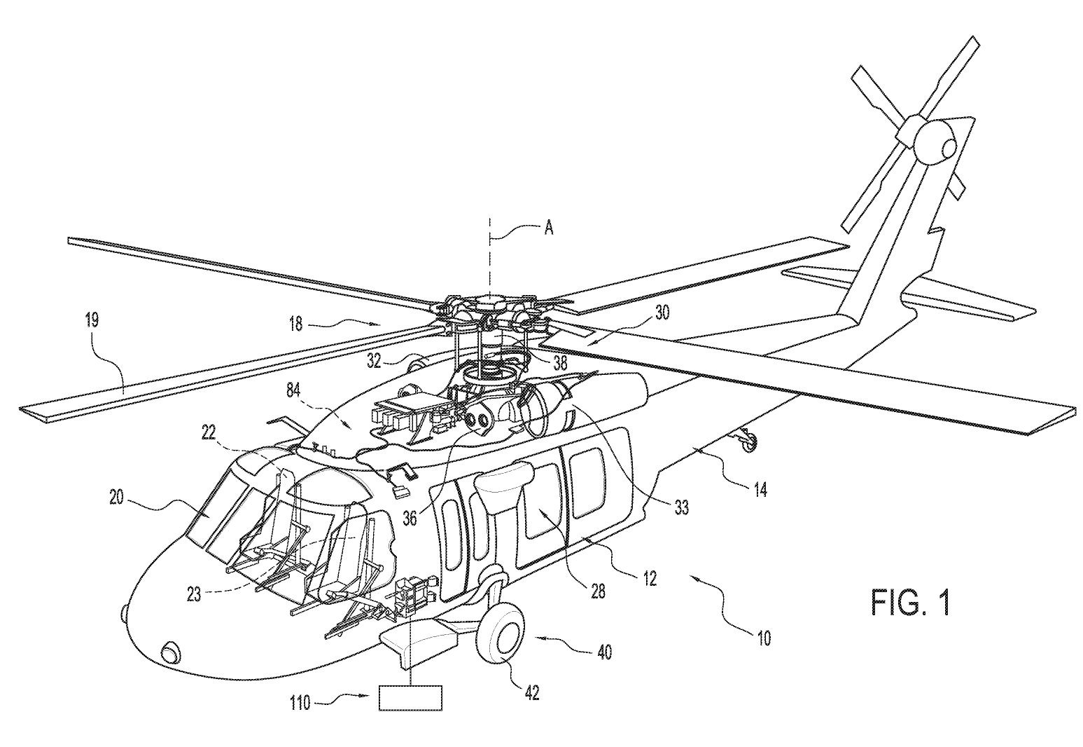

### DETAILED DESCRIPTION

A detailed description of one or more embodiments of the disclosed apparatus and method are presented herein by way of exemplification and not limitation with reference to the Figures.

A vertical take-off and landing (VTOL) aircraft 10 having an airframe 12 including an extending tail 14. Airframe 12 supports a main rotor assembly 18 having a plurality of rotor blades, one of which is indicated at 19 that rotate about an axis “A”. VTOL aircraft 10 also includes a cockpit 20 having a first seat 22 and a second seat 23. First and second seats 22 and 23 may accommodate a pilot and a co-pilot for example. VTOL aircraft 10 also includes a passenger compartment 28 that may accommodate individuals, cargo or the like.

VTOL aircraft 10 also includes one or more prime movers 30 which, in the exemplary embodiment shown, take the form of a first engine 32 and a second engine 33. First and second engines 32 and 33 are mechanically linked to a gearbox 36 which, in turn, is mechanically linked to main rotor assembly 18 through a main rotor shaft 38. VTOL aircraft 10 may include support members 40 shown on the form of wheels 42. Of course, it is to be understood that support members 40 may take on a variety of forms including retractable landing gear or skids.

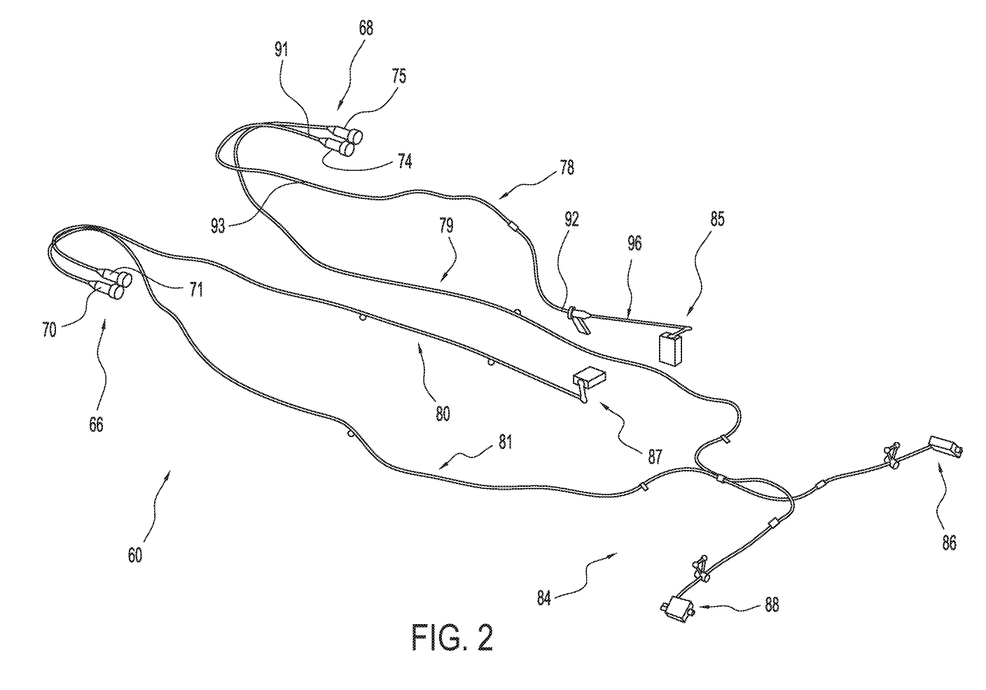

Referring to FIG. 2, VTOL aircraft 10 includes a control system 60 having a first engine control spindle system 66 associated with first engine 32 and a second engine control spindle system 68 associated with second engine 33. First engine control spindle system 66 may include aircraft control members such as a first engine control spindle 70 and a second engine control spindle 71. Second engine control spindle system 68 includes additional aircraft control members such as a third engine control spindle 74 and a fourth engine control spindle 75. First and third engine control spindles 70 and 74 may control engine load state such as, for example, engine off, engine idle, fly, lockout and the like. Second and fourth engine control spindles 71 and 75 may control engine load or power.

A first engine control cable 78 is mechanically connected to first engine control spindle 70. A second engine control cable 79 is mechanically connected to second engine control spindle 71. A third engine control cable 80 is mechanically connected to third engine control spindle 74, and a fourth engine control cable 81 is mechanically connected to fourth engine control spindle 75. As will be detailed herein, first, second, third, and fourth engine control cables 78, 79, 80, and 81 transmit commanded control inputs to first and second engines 32 and 33.

In accordance with an exemplary embodiment, VTOL aircraft 10 includes a fly-by-wire mechanical control system 84. It is to be understood that the phrase “fly-by-wire mechanical control system” describes a fly-by-wire system integrated with legacy or existing cables that form part of a mechanically actuated control system. More specifically, the fly-by-wire mechanical control system described herein may be incorporated into existing aircraft or aircraft already in production that are outfitted with mechanical control systems.

Fly-by-wire mechanical control system 84 includes a first electro-mechanical actuator (EMA) 85, a second EMA 86, a third EMA 87, and a fourth EMA 88. First EMA 84 is mechanically connected to first engine control spindle 70 via first engine control cable 78. Second EMA 86 is mechanically connected to second engine control spindle 71 via second engine control cable 79, third EMA 87 is mechanically connected to third engine control spindle 74 via third engine control cable 80, and forth EMA 88 is mechanically connected with fourth engine control spindle 75 via forth engine control cable 81.

For example, first engine control cable 78 includes a first end 91 mechanically connected with first engine control spindle 74, a second end 92 mechanically connected with first EMA 85 and an intermediate portion 93 extending therebetween. Second end 92 may be connected with first EMA 85 via a linkage 96. Second, third, and fourth EMA's 86-88 may be connected to corresponding second, third, and fourth engine control spindles 71, 74, and 75 in a similar manner.

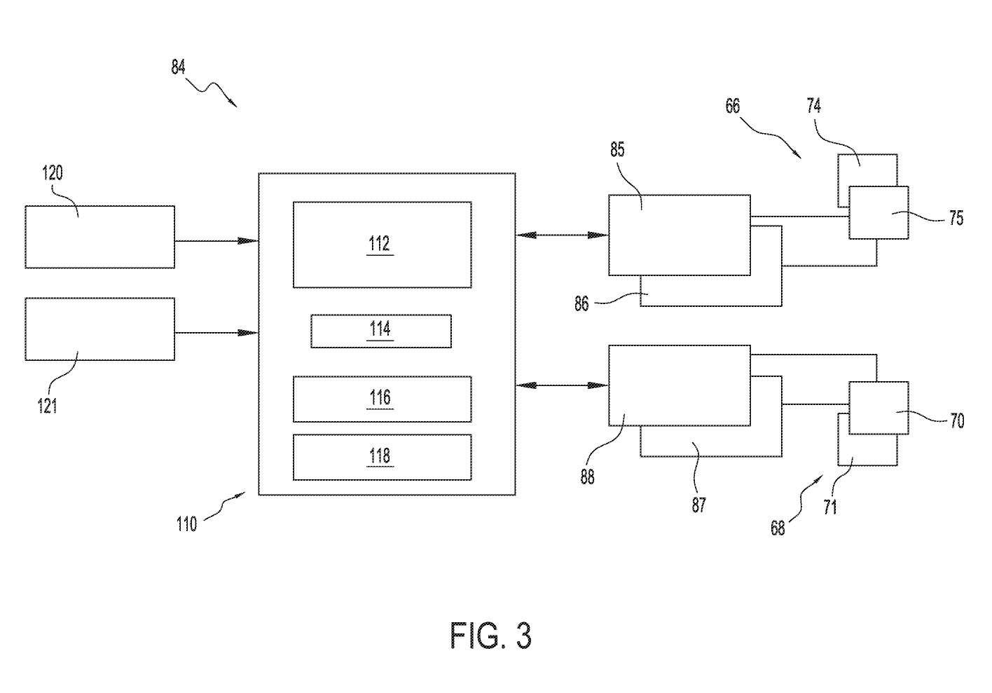

Fly-by-wire mechanical control system 84 also includes a fly-by-wire controller 110 electrically connected to each of the first, second, third, and fourth EMA's 85-88 as shown in FIG. 3. Fly-by-wire controller 110 includes a central processing unit (CPU) 112, and a non-volatile memory 114. In accordance with an exemplary aspect, fly-by-wire controller 110 may include, or may be functionally connected with, a vehicle management system (VMS) module 116, and a feedback control module 118. As will be detailed herein, vehicle management system module 116 may adjust a position of one or more of EMA's 85-88 based on commanded inputs through, for example, a first control inceptor 120 and/or a second control inceptor 121. Each of the first and second control inceptors 120 and 121 may take the form of a collective drive system (not separately labeled) of VTOL aircraft 10.

In accordance with an exemplary aspect, a commanded input is received by fly-by-wire controller 110 through, for example, aircraft control inceptor 120. It is to be understood that aircraft control inceptor 120 may be physically present in VTOL aircraft 10 or may be part of a ground control system (not shown). The commanded input is processed by, for example, vehicle management system module 116 and a control output is passed to one or more of first, second, third, and/or fourth EMA's 85-88. The corresponding one or more of first, second, third, and/or fourth EMA's 85-88 shifts a respective one of first, second, third and/or fourth engine control cables 78-81. The one or more of the first, second, third and/or fourth engine control cables 78-81 acts upon an associated one of first and second engine control spindle systems 66 and 68 resulting in a change in operating state of first and/or second engine 32, 33.

In further accordance with an exemplary aspect, each of the first, second, third, and fourth EMAs 85-88 may provide a feedback signal to fly-by-wire controller 110 and/or to feedback control module 118. The feedback may represent a status of a corresponding one of first, second, third, and fourth engine control cables 78-81. That is, if first EMA 85 must exert more or less than a threshold amount of force when commanded to shift first engine control cable 78, a signal may be sent to fly-by-wire controller 110 indicating that a problem may exist. In this manner, each of the first, second, third, and fourth EMAs 85-88 may provide an activation status of corresponding ones first, second, third, and fourth engine control cables 78-81. That is, each EMA 85, 86, 87, and 88 may detect whether the associated one of each engine control cable 78, 79, 80, and 81 may be compromised in some manner.

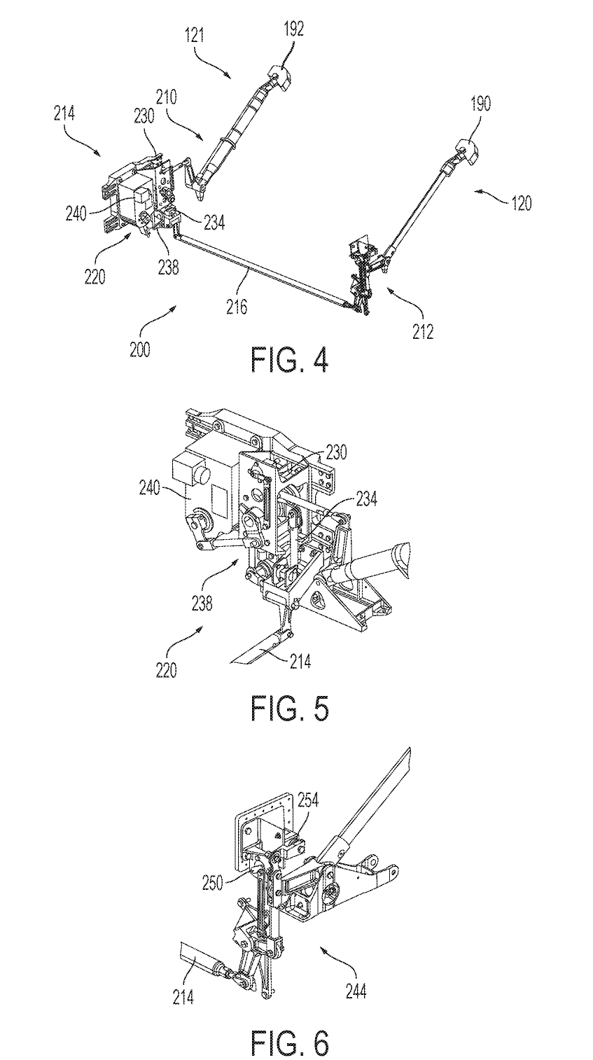

In accordance with another aspect of an exemplary embodiment depicted in FIG. 4, first control inceptor 120 may take the form of a first or pilot collective 190 and second control inceptor 121 may take the form of a second or co-pilot collective 192. First and second collectives 190, 192 form part of a control inceptor drive system 200. Control inceptor drive system 200 includes a first or pilot portion 212 and a second or co-pilot portion 214 operatively connected to one another through a mechanical linkage 216. Mechanical linkage 216 couples inputs from, for example, pilot portion 212 to co-pilot portion 214.

Co-pilot portion 214 includes an inceptor drive system 220 having a first rotary variable differential transformer (RVDT) 230 and a second RVDT 234. First and second RVDT's 230, 234 report collective position to (VMS) module 116 which, in turn, provides control inputs to first and third EMAs 85 and 87 as well as provide collective blade pitch inputs. Collection position may also be employed to control collective main rotor pitch. Inceptor drive system 220 also includes a damper 238 and a servo 240. Damper 238 controls movement of second control inceptor 121. Servo 240 may provide feedback to a co-pilot such as feel characteristics, tactile feedback, VMS commanded positions, and the like. Servo 240 may also apply feedback to first control inceptor 120 through mechanical linkage 216.

Pilot portion 212 may include a drive system 244 having an RVDT 250 and a damper 254. RVDT 250 provides collective position to (VMS) module 116 which, in turn, provides control inputs to first, second, third, and fourth EMA's 85-88. In accordance with an exemplary aspect, RVDT's 230, 234, and 250 cooperate to provide desired control inputs to first, second, third, and fourth EMA's 85-88 as well as provide collective blade pitch inputs. The use of RVDT's 230, 234, and 250 enables control of aircraft 10 in the event of a disconnect between pilot portion 212 and co-pilot portion 214. Thus, control inceptor drive system 200 may be employed to retrofit or refit a rotary wing aircraft with fly-by-wire capabilities.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fly-by-wire mechanical control system comprising:
at least one engine control spindle mechanically connectable to an aircraft prime mover;
at least one engine control cable including a first end connected to the at least one engine control spindle, a second end, and an intermediate portion extending therebetween; and
at least one electro-mechanical actuator mechanically connected to the second end of the at least one engine control cable and electrically connected to an aircraft control member.

2. The fly-by-wire mechanical control system according to claim 1, wherein the aircraft control member comprises an aircraft control inceptor.

3. The fly-by-wire mechanical control system according to claim 2, wherein the aircraft control inceptor comprises a collective drive system.

4. The fly-by-wire mechanical control system according to claim 1, wherein the aircraft control member comprises a vehicle management system controller.

5. The fly-by-wire mechanical control system according to claim 1, wherein the at least one electro-mechanical actuator comprises a first electro-mechanical actuator and a second electro-mechanical actuator.

6. The fly-by-wire mechanical control system according to claim 5, wherein the first electro-mechanical actuator comprises at least one power available electro-mechanical actuator and the second electro-mechanical actuator comprises at least one load demand electro-mechanical actuator.

7. The fly-by-wire mechanical control system according to claim 1, further comprising: a feedback system operatively connected to at least one of the at least one engine control spindle and the at least one electro-mechanical actuator, the feedback control system providing activation state information of the at least one engine control cable.

8. The fly-by-wire mechanical control system according to claim 1, further comprising: a control inceptor drive system electrically connecting a first control inceptor and a second control inceptor with the at least one electro-mechanical actuator (EMA).

9. The fly-by-wire mechanical control system according to claim 8, wherein the control inceptor drive system includes one or more rotary variable differential transformers (RVDT) operatively connecting the first and second control inceptors with the at least one EMA.

10. The fly-by-wire mechanical control system according to claim 8, wherein the control inceptor drive system includes at least one servo mechanically connected to each of the first and second control inceptors.

11. An aircraft comprising:
an airframe;
a prime mover supported in the airframe;
an aircraft control member operatively selectively operable to affect a state of the prime mover; and
a fly-by-wire mechanical control system including:
at least one engine control spindle mechanically connected to the prime mover;
at least one engine control cable including a first end connected to the at least one engine control spindle, a second end, and an intermediate portion extending therebetween; and
at least one electro-mechanical actuator mechanically connected to the second end of the at least one engine control cable and electrically connected to the aircraft control member.

12. The aircraft according to claim 11, wherein the aircraft control member comprises an aircraft control inceptor.

13. The aircraft according to claim 12, wherein the aircraft control inceptor comprises a collective drive system.

14. The aircraft according to claim 11, wherein the aircraft control member comprises a vehicle management system controller.

15. The aircraft according to claim 11, wherein the at least one electro-mechanical actuator comprises a first electro-mechanical actuator and a second electro-mechanical actuator.

16. The aircraft according to claim 15, wherein the first electro-mechanical actuator comprises at least one power available electro-mechanical actuator and the second engine control spindle comprises at least one load demand electro-mechanical actuator.

17. The aircraft according to claim 11, further comprising: a feedback system operatively connected to at least one of the at least one engine control spindle and the at least one electro-mechanical actuator, the feedback control system providing activation state information of the at least one engine control cable.

18. The aircraft according to claim 11, further comprising: a control inceptor drive system electrically connecting a first control inceptor and a second control inceptor with the at least one electro-mechanical actuator (EMA).

19. The aircraft according to claim 18, wherein the control inceptor drive system includes one or more rotary variable differential transformers (RVDT) operatively connecting the first and second control inceptors with the at least one EMA.

20. The aircraft according to claim 18, wherein the control inceptor drive system includes at least one servo mechanically connected to each of the first and second control inceptors.
